(19) United States
(12) Patent Application Publication
(10) Pub. No.: US 2017/0371910 A1
(43) Pub. Date: Dec. 28, 2017

(54) REAL-TIME SHARD REBALANCING FOR VERSIONED ENTITY REPOSITORY

(71) Applicant: MICROSOFT TECHNOLOGY LICENSING, LLC, Redmond, WA (US)

(72) Inventors: Dong Kwon Joo, Issaquah, WA (US); Fernando de la Garza Martinez, Kirkland, WA (US); Edmundo Martinez Rodriguez, Kirkland, WA (US); Kevin S. O'Donnell, Kirkland, WA (US); Beom Seok Oh, Kirkland, WA (US); Eduard Leonardo Zambrano Sanchez, Duvall, WA (US); Ibrahim Durmus, Sammamish, WA (US)

(21) Appl. No.: 15/195,101

(22) Filed: Jun. 28, 2016

(51) Int. Cl. G06F 17/30

(52) U.S. Cl. CPC G06F 17/30345; G06F 17/30336; G06F 17/30356

(57) ABSTRACT

In various embodiments, methods and systems for rebalancing database shards are provided. Candidate entities in the database shards are identified for rebalancing. The candidate entities have corresponding existing locations in the database shards. New locations are determined for the candidate entities in the database shards. A shard map is created that identifies the new locations in the database shards for the identified candidate entities. When data for the identified candidate entities is received, the data for the identified candidate entities is written to the locations in the database shards identified in the shard map. Existing data for the identified candidate entities is maintained at their corresponding existing locations in the database shards.

### BACKGROUND

Database shards generally refer to partitioned data portions of databases. Shard-based database partitioning improves the performance and scalability of databases by storing the data of a database in multiple horizontally-partitioned databases. Conventionally, while all of the database shards of the database may share a common schema, each shard has its own subset of data that is independent of the data in the other database shards. Thus, a transaction on the database can be performed on a single database shard instead of on the entire database, and transactions can be distributed across the multiple database shards. Although shards provide a beneficial structure for storing data, further improvements in database storage are still desirable.

### SUMMARY

Embodiments described herein are directed to methods, systems, and computer storage media for real-time rebalancing of database shards. Databases can store data as entities, which can refer to some unit of data that can be classified or have stated relationships with other entities. A candidate entity is an entity in the database that is identified for rebalancing. In some embodiments, in operation, candidate entities in the database shards are identified for rebalancing and new locations in the database shards for the candidate entities are determined. A new shard map is created that identifies the new locations in the database shards for the candidate entities. Based on receiving data for the candidate entities, the received data can be written to the new locations identified in the new shard map. Furthermore, the data can have a version number to identify which version of the candidate entity is the latest version. Thus, existing data (i.e., prior versions) for the candidate entities is not moved from existing locations in the database shards and new data (i.e., latest versions) is written to the new locations identified in the shard map.

In some embodiments, a system can be provided that identifies which database shards need rebalancing, i.e., database shards can be identified when the shard is, e.g., overutilized or underutilized. Entities in the shard(s) that are overutilized can be stored to other database shards, and underutilized database shards can store additional entities (or entities with a higher transaction rate) so that the database shards become balanced. A new shard map is created that identifies the new locations in the database shards for the entities. In particular, at least a subset of entities may now have new locations. This new shard map becomes the default shard map and later transactions can use this map. Based on receiving data for the database shards, the data can be written to the locations identified in the new shard map. Thus, data for the subset of entities with new locations is created in the new locations identified in the new shard map and old data associated with the subset of entities is not moved from existing locations in the database shards.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

The present invention is described in detail below with reference to the attached drawing figures, wherein:

FIG. 1 is a block diagram of an exemplary database shard environment in which embodiments described herein may be employed;

FIG. 2 is a block diagram illustrating an exemplary database shard environment in which the database shards are unbalanced;

FIG. 3 is a block diagram illustrating an exemplary database shard environment in which balancing is performed on the database shards, in accordance with embodiments described herein;

FIG. 4 is a flow chart showing an exemplary method for rebalancing database shards, in accordance with embodiments described herein;

FIG. 5 is a flow chart showing another exemplary method for rebalancing database shards, in accordance with embodiments described herein; and

FIG. 6 is a block diagram of an exemplary distributed computing system suitable for use in implementing embodiments described herein.

### DETAILED DESCRIPTION

Shard-based database partitioning improves the performance and scalability of a database by storing data in database shards. Database shards can operate on physically or virtually separated computing components or devices. Database shards can become unbalanced, thus degrading performance of those database shards because of skewed transaction loads between the shards. For example, if a particular database shard is accessed frequently, e.g., many transactions are performed on the shard, performance of the database shard may degrade or a large amount of resources may be required. Furthermore, if a particular database shard is infrequently accessed, it may be desirable to place more entities or entities that are accessed frequently in that shard, to improve overall performance of the database shards and make better use of resources.

The database shard system may perform operations to balance the database shards. For example, when new entities are added to the database, those entities may be added to shards that are underutilized. However, the above approach does not completely solve the problem with unbalanced database shards since, e.g., (1) transactions may initially be skewed towards the database shards that store the new entities, and (2) adding new entities to underutilized shards does not resolve the issue where existing entities should be relocated in order to balance the database shards. Thus, there exists a need in the industry for approaches to rebalancing database shards.

One solution for rebalancing database shards has been to move data between shards to rebalance the shards. For example, if a database shard is experiencing a high volume of transactions, entities from that shard can be moved to another database shard, reducing the transaction load on the first shard. Move operations can continuously be performed to ensure that the database shards are balanced. However, this approach often requires the database shards to be unavailable for periods of time (as the data is migrated) and also runs the risk of an error occurring during the migration, causing the data to be lost or corrupted.

The term “entity” is defined herein as an entry of the database that is stored in a database shard. Since the database shards may share a common schema, an entity can freely be located in any of the database shards corresponding to the database. Thus, when an entity is updated to a new database shard, the entire entity is updated at that shard location. An entity may also be referred to as a row of the database.

A “transaction” is defined herein as an operation performed on an entity of a database shard. Examples of operations include read operations (e.g., reading data from the entity) and write operations (e.g., updating the data for the entity).

Embodiments described in this disclosure are directed to methods and systems for rebalancing database shards by utilizing a versioned shard map. For example, a new shard map can be created that identifies new locations for entities in the database shards to rebalance the shards. When data is written to the database shards, the data is written to the new location indicated in the shard map, allowing the entities and data associated with the entities to be stored at new locations in real-time. In other words, when data is added to the database, instead of moving the data for an entity from its old location to the new location, the data can be directly written to the new location. Version identifiers for the entities and shard map are used to identify the latest versions of the data. Since the shard map points to the new location, future transactions performed on an entity can be performed on the latest version of the data located at the new location identified by the latest shard map.

Since an entity (i.e., data for an entity) is written to the location indicated in the shard map with a new version number, existing data for an entity does not need to moved or deleted (e.g., versions of prior entities can be maintained in the database shards). The new data for the entity can be accessed by its new location. Furthermore, new shard maps can be created when external data is received. For example, in some embodiments, data associated with a version of the database is sent to a customer. The customer can send back the data having changes to the database. The data having changes received from the customer is written to the database shards according to the shard map, allowing for fast updates to the data. Since the rebalancing is performed on the shard map prior to the customer data being received, data does not need to be moved to the new locations (the data comes from the customer).

Entities can be stored as different versions of the entity, each version possibly having different data for the entity. For example, if an entity is updated (e.g., the data for the entity is changed), different versions of the entity can have different values (e.g., before and after the update). Entities can be distinguished by the version identifier. A shard map containing the locations of the entities can also be versioned. Thus, different shard maps can identify different versions of the data. A shard map and its corresponding entities can share a version identifier. Thus, when data is written for an entity, the version of the entity can match the version of the shard identifying where the entity should be written. In some embodiments, a shard map and corresponding entities in the database shard may have different version identifiers. Thus, the shard map can also store version identifiers for the entities and their storage location.

Data for prior versions of an entity need not be removed. The latest version of the shard map points to the latest version of the entities and not prior versions of the entities. Thus, prior versions of the entities are not referenced by the latest version of the shard map. However, prior shard maps may still reference prior versions of entities. Thus, if a prior version of a shard map references a prior version of an entity, that version of the entity may still be accessed using the prior shard map. In some embodiments, a garbage collection or archiving process may remove older versions of entities and shard map. Thus, only the latest version(s) of an entity may exist in the database shards. In some embodiment, a later version of an entity may replace a prior version of an entity (e.g., data for the entity is updated on the database shard).

For purposes of a detailed discussion below, embodiments are described with reference to a distributed computing environment supporting a cloud computing platform, for example, distributed computing environment 600 and cloud computing platform 610, described herein. However, the operations described herein can be performed in different types of operating environments having alternate configurations of the functional components described herein. As such, the embodiments described herein are merely exemplary, and it is contemplated that the techniques may be extended to other implementation contexts.

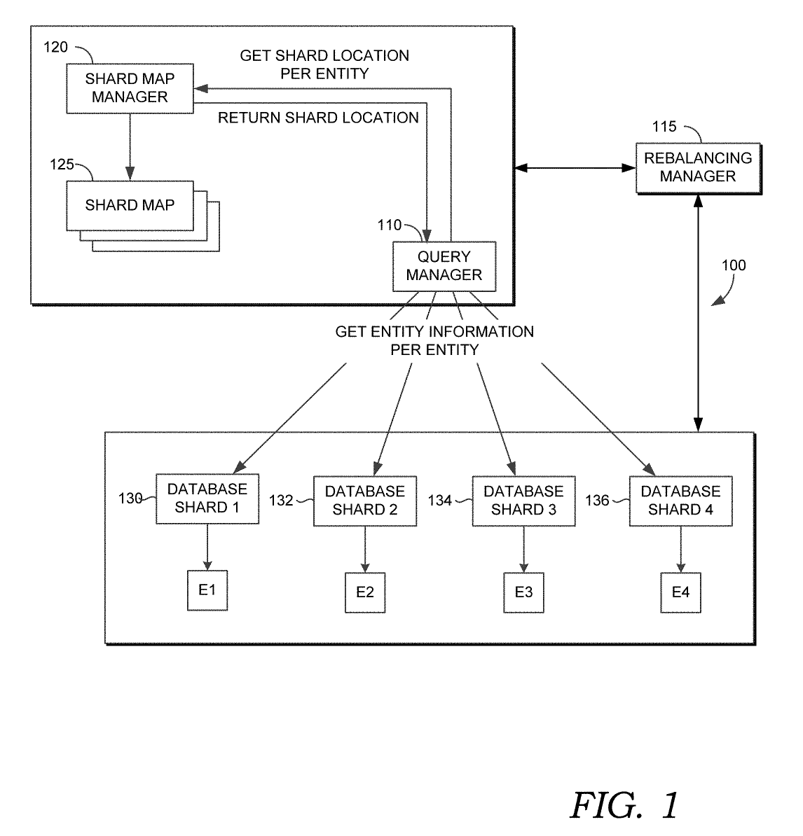

With reference to FIG. 1, an exemplary database shard environment 100 for shard-based database partitioning is illustrated. The database shard environment 100 comprises a query manager 110, a rebalancing manager 115, a shard map manager 120, one or more shard maps 125, and a plurality of shards 130, 132, 134, 136. It should be understood that this and other arrangements described herein are set forth only as examples. Other arrangements and elements (e.g., machines, interfaces, functions, orders, groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

The query manager 110 receives requests (e.g., queries) to read/write entities from/to the database shards 130, 132, 134, 136. In some embodiments, a request is received from user via a user interface. In another embodiment, a request is received via an API. It should be understood that the foregoing examples are for illustrative purposes only and there may exist other ways for the query manager 110 to receive requests. For example, a batch process can be executed that performs transactions on the database shards 130, 132, 134, 136. When the query manager 110 receives a request, it communicates with the shard map manager 120 to obtain the shard location of the entity/entities in the database shards 130, 132, 134, 136 that correspond to the request. For example, if the query manager 110 receives a request to perform a transaction on an entity, e.g., E3, the query manager 110 communicates with the shard map manager 120 to identify the location of E3. The shard map manager 120 may communicate back to the query manager 110 that the entity is found at Shard 3. In some embodiments, if a transaction is to be performed on multiple entities, the query manager 110 sends a separate communication to the shard map manager 120 for each entity in the transaction request. In some embodiments, the query manager 110 stores data for the entities to the database shard locations identified in the shard map. Thus, as new data comes in, the query manager 110 performs operations to store the new data for the entities to the database shard locations identified in the shard map. The existing data for the entities is not moved from the corresponding existing locations in the database shards.

The shard map manager 120 comprises the shard map 125 identifying the entities in the database and their corresponding database shard locations. This allows the location of the database shard to be easily identified for an entity. In some embodiments, the shard map 125 may comprise a version identifier to distinguish it from other shard maps (e.g., previous version of the shard map). Data that is saved to the database shard locations identified in the shard map 125 can share the same version identifier. In some embodiments, the shard map 125 may also store a version identifier of the entity. For example, an entry in the shard map 125 may indicate that E3 version 1 is located at shard 3. Thus, the shard map 125 and entity can also have different version identifiers. When new data is received, e.g., from a customer data file, if a new shard map 125 is created, the version number for the shard map 125 and the entities identified in the shard map 125 can be incremented allowing identification of the latest version of the entities. In the above description, a new shard map is created. In some embodiments, an existing shard map may be updated instead of a new shard map being created. Thus, the locations of the entities can be written to an existing shard map. Even if the shard map is updated instead of a new shard map being created, resources can be saved since the process can still be performed in real-time (e.g., since only the shard map is updated, data is not moved between database shards saving time and resources). In some embodiments, the shard map manager 120 creates the new shard map that identifies the database shard locations in the database shards for new entity data.

The database shard environment 100 can further include the rebalancing manger 115. The rebalancing manager 115 operates to support real-time rebalancing of database shards in accordance with techniques described herein. In this regard, the rebalancing manager 115 is operably and communicatively coupled to the query manager 110, the shard map manager 120, the shard map 125, and the plurality of databases shards 130, 132, 134, 136. In particular, the rebalancing manager 115 can identify database shards for rebalancing and communicate candidate entities and their corresponding old and new locations to the shard map manager 120. The shard map manager 120 can create a new shard map 125 with the new location information from the rebalancing manager 115. It should be understood that the rebalancing manager 115 may be a separate component or be part of the query manager 110, shard map manager 120, or plurality of database shards 130, 132, 134, 136. For example, the query manager 110 can send a request to rebalance the plurality of database shards 130, 132, 134, 136. After receiving a new shard map 125, the query manager 110 can store new data to the new respective location in the plurality of database shards 130, 132, 134, 136.

When the shard map manager 120 receives a request for the shard location of an entity, the shard map manager 120 looks up the entity in the shard map 125. The shard map manager 120 then returns the location of the database shard that contains the requested entity, e.g., shard location. In some embodiments, in the case that an entity is not found in the shard map 125, e.g., a new entity, the shard map manager 120 can create a new entry for the entity in the shard map 125, storing the entity to a database shard. In some embodiments, the database shard to which the entity is stored can be determined based on, e.g., the current load or the number of entities on the database shard.

The query manager 110 uses the shard location returned by the shard map manager 120 to retrieve the entity from the database shard indicated in the shard map 125. In the above example, if the query manager 110 requests the entity information for E3, it may send the request to database shard 136, on which E3 is located.

The plurality of database shards 130, 132, 134, 136 comprise the data of the database. Each shard contains a subset of the data of the database and transactions can be performed on the shard as an individual database. All of the database shards share a common schema and any of the shards can be used to contain data for the database. Since each shard can be constructively treated as its own database, transactions on the shard only affect that shard. In other words, the data in the shard does not overlap with data in other shards. If a transaction is performed on the database, e.g., an entity is updated, the transaction is only performed on the database shard containing the entity. Furthermore, since a database shard is independent of other database shards, new shards can be easily added to the database without affecting the other shards.

Having described various aspects of an exemplary database shard environment 100, it is noted that any number of components may be employed to achieve the desired functionality within the scope of the present disclosure. Although the various components of FIG. 1 are shown with lines for the sake of clarity, in reality, delineating various components is not so clear, and metaphorically, the lines may more accurately be grey or fuzzy. Further, although some components of FIG. 1 are depicted as single components, the depictions are exemplary in nature and in number and are not to be construed as limiting for all implementations of the present disclosure.

It should be understood that this and other arrangements described herein are set forth only as examples. Other arrangements and elements (e.g., machines, interfaces, functions, orders, and/or groupings of functions) can be used in addition to, or instead of, those shown, and some elements may be omitted all together. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions, including the functions described below, may be carried out by a processor executing instructions stored in memory.

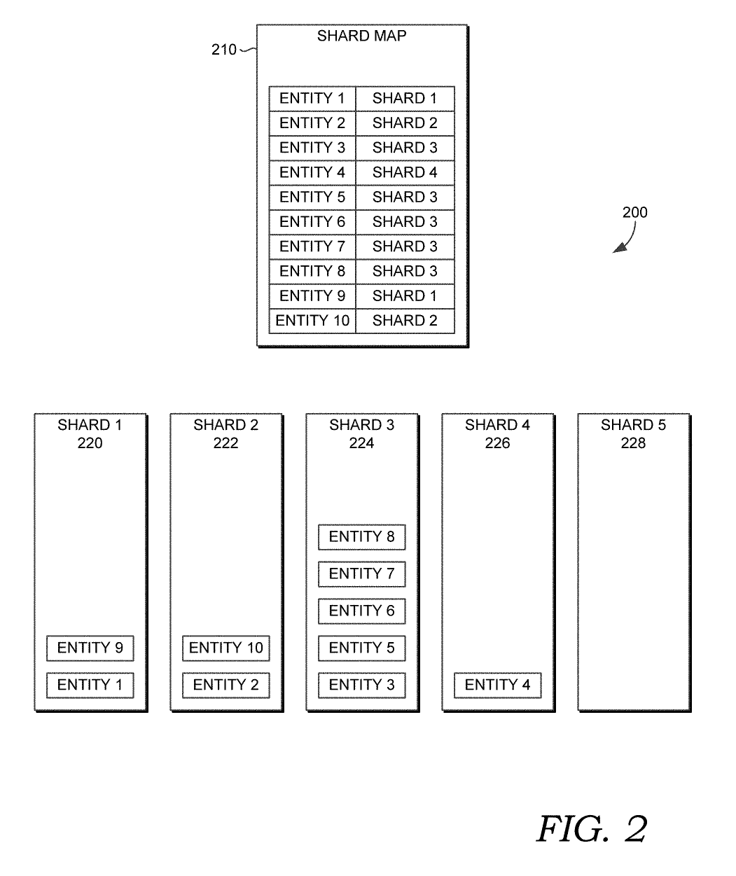

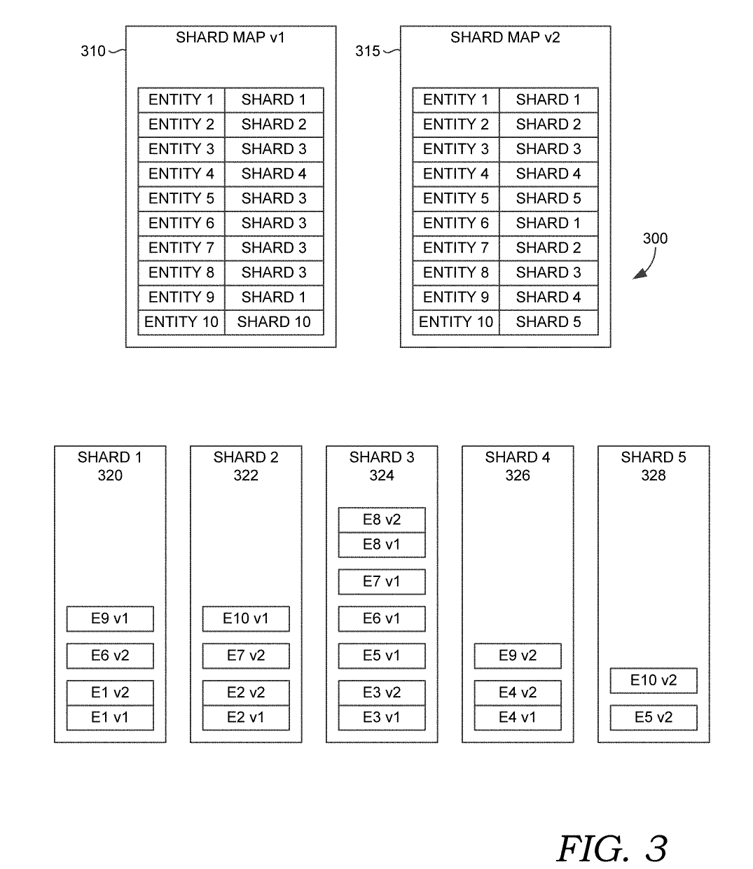

With reference to FIGS. 2 and 3, an exemplary database shard environment is illustrated in which the database shards are unbalanced and then are rebalanced, respectively. FIG. 2 shows an initial state where the database shards are unbalanced, and FIG. 3 shows the transition of the database shards to a rebalanced state.

With reference to FIG. 2, an exemplary database shard environment 200 is illustrated where the database shards are unbalanced. The database shard environment 200 includes a shard map 210 and database shards 220, 222, 224, 226, 228. Shard 1 (220) contains entities 1 and 9. Shard 2 (222) contains entities 2 and 10. Shard 3 (224) contains entities 3, 5, 6, 7, and 8. Shard 4 (226) contains entity 4. Shard 5 (228) does not contain any entities.

The shard map 210 identifies the entities in the database shards and their corresponding location in the database shards. For example, the shard map 210 may indicate that entity 1 resides in shard 1, entity 2 resides in shard 2, entity 3 resides in shard 3, etc.

As shown in FIG. 2, Shard 3 (224) contains five entities (2, 5, 6, 7, 8). Under normal operation, Shard 3 (224) may have a higher transaction load than to the other shards due to it having more entities. This leads to high utilization of Shard 3 (224), which may result in slow performance of Shard 3 (224). On the other hand, Shard 5 (228) does not have any entities. Thus, Shard 5 (228) may not be utilized at all.

With reference to FIG. 3, an exemplary database shard environment 300 is illustrated in which rebalancing is performed on the database shards. Initially, Shard 1 (320) contains entities 1 and 9, Shard 2 (322) contains entities 2 and 10, Shard 3 (324) contains entities 3, 5, 6, 7, and 8, Shard 4 (326) contains entity 4, and Shard 5 (328) does not contain any entities. The initial states of the data are given a version number, v1 (e.g., E1 v1, E2 v1, E3 v1, etc.). The entities and the shard location are indicated in sharp map 310 corresponding to version 1.

Shard map 310 and 315 contain a listing of all entities and their corresponding database shard. In some embodiments, shard maps 310 and 315 include a version identifier to distinguish the shard map from previous versions of the shard map. The entity and location of the database shard in shard maps 310 and 315 correspond to the version identifier of the shard map 310. For example, FIG. 3 shows a version 1 of a shard map (310) and a subsequent version 2 of a shard map (315). Shard map 315 may indicate that version 2 of E5 (e.g., E5 v2) is located at shard 5 (whereas version 1 of E5 was located at shard 3). In some embodiments, the latest version identifier of the shard map corresponds to the latest version identifier of the entity.

When rebalancing is to be performed on the database shards 320, 322, 324, 326, 328, a new shard map 315 (Shard Map v2) is created. The shard map 315 indicates new locations for the entities that are to be relocated to a new database shard. For example, entity 6, which was initially in Shard 3 (324) is now identified as being in Shard 1 (320). Entity 7 is now identified as being in Shard 2 (322). As data is written to the database shards 320, 322, 324, 326, e.g., data for entity 5 is written to Shard 5 (328) instead of Shard 3 (324), data for entity 6 is written to Shard 1 (320) instead of Shard 3 (324), data for entity 7 is written to Shard 2 (322) instead of Shard 3 (324), data for entity 9 is written to Shard 4 (326) instead of Shard 1 (320), and data for entity 10 is written to Shard 5 (328) instead of Shard 2 (322). Data for entities 1, 2, 3, 4, and 8 remain in their respective database shards. Thus, after the new data is written to the locations indicated in new shard map 315, the database shards become balanced allowing for improved performance across the database shards. In some embodiments, data is also received for entities that are not selected for rebalancing. The data for entities not selected for rebalancing can be used to, e.g., update an existing entity or create a new entity. For example, an entity that is not selected for rebalancing is not updated as the new data is received, but instead a new version of the entity is written to the shard. Thus, two or more versions of an entity can be located on a single database shard.

Since the data in the database shards 320, 322, 324, 326 is versioned, multiple copies of the data can exist in the database shards 320, 322, 324, 326. However, the system can retrieve the latest version of the entity (e.g., v2), thereby resolving multiple instances of data. In some embodiments, a garbage collection or archiving process is run periodically to remove the previous versions of the entities (e.g., v1). A garbage collection or archiving process also allows the size of the database shards in the database to be reduced if they are, e.g., no longer required, saving resources of the database shards.

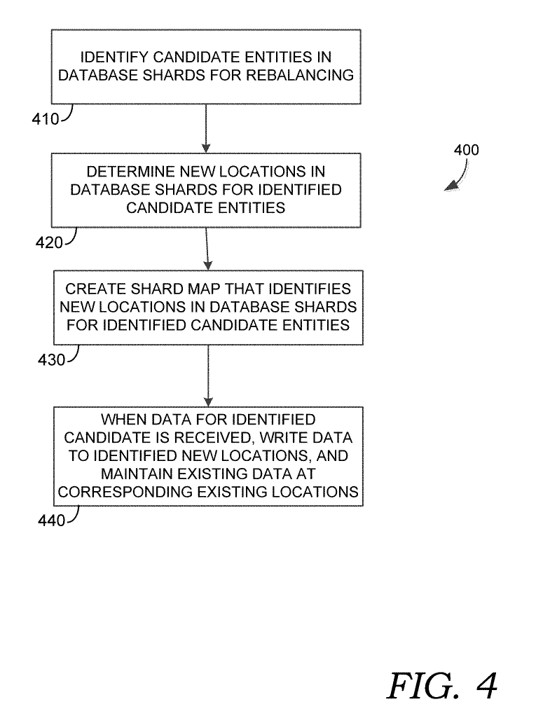

With reference to FIG. 4, a flow diagram that illustrates an exemplary method 400 for rebalancing database shards is provided.

At block 410, candidate entities in the database shards are identified for rebalancing. In some embodiments, performance of the database shards is analyzed. For those shards that have poor performance, entities can be identified to be relocated to other database shards. In some embodiments, entities in the database shards that have a high utilization rate may be candidates for relocation based on the performance of the rest of the data shards.

At block 420, new locations in the database shards are determined for the identified candidate entities. In some embodiments, performance of the database shards is analyzed. For database shards that are underutilized, those shards can be used as new locations for the candidate entities in block 410.

At block 430, a shard map is created that identifies the new locations in the database shards for the identified candidate entities. For example, the candidate entities identified in block 410 can be associated with database shards determined in block 420. In some embodiments, the shard map is given a new version identifier to distinguish the shard map from previous shard maps. The new shard map can be a default shard map. For examples, for queries that do not specify a version of the entity, the shard map can return the location of the latest version of the entity. In some embodiments, the new shard map can increment the version number of the previous shard map to get a new version number. The entities in the new shard map can also receive the new version number, i.e., a version number incremented from the previous version number. In some embodiments, a new shard map may contain locations for all entities in the database shard. In some embodiments, the new shard map may contain the same number of entities as the previous shard map, where new locations are indicated for the corresponding entities in the new shard map. For example, if entity 1 is relocated from Shard 1 to Shard 2, the previous shard map may contain the entry E1:S1 and the new shard map contains the entry E1:S2. It should be understood that the above notation is for illustrative purposes, and that the entries in the shard map may be of a different format that indicates the entity and its corresponding location.

At block 440, when data for the identified candidate entities is received, the data for the identified candidate entities is stored to the new locations in the database shards identified in the shard map. In some embodiments, data for the database is received from an external source, e.g., as a customer data file. For example, a customer may send a copy of the database that contains the customer updates as a data file. The data file gets loaded to the database shards as new entities. In other words, new entities are created for the identified candidate entities. In some embodiments, the new entities are given a version identifier that corresponds to the shard map created in block 430. The existing data for the identified candidate entities in the data shards, i.e., the previous versions of the data, is not moved from their corresponding existing locations in the database shards. In some embodiments, a garbage collection or archiving process can remove entities that correspond to earlier version numbers.

In some embodiments, a newly created database shard can be added to the database (i.e., the pool of database shards). Since the new database shard initially does not contain any entities, it is likely to become a candidate for a new location for a relocated entity. Thus, new entities can be relocated to the new database shard.

In some embodiments, data for entities not identified for rebalancing can be received. If an entity exists for that entity, the data can be stored at the same database shard (i.e., existing location) as a new version of the entity. In some embodiments, the entity is updated with the new data instead of a new version of the entity being created.

In some embodiments, a new shard map replaces the previous shard map. Since versioning is performed on the shard maps, the old version of the shard map may still be retained. However, operations on the database may be set to use the latest version of the shard map. By retaining the older shard maps, previous versions of data can still be accessed (prior to the data being garbage collected). The old data and location may be determined by a previous shard map and the new data and location may be determined by the new shard map. Thus, previous versions of the entity may be accessed by their version number.

In some embodiments, prior to identifying the candidate entities, an indication to rebalance the database shards may be received. For example, the database shard system may determine that at least one of the database shards is exhibiting reduced performance and thus the database shards should be rebalanced. As another example, the rebalancing may be performed on a preset schedule, e.g., weekly, monthly, etc. The determination to rebalance database shard is not limited to the above examples, and any means of determining to rebalance database shards may be employed. For example, a request is received by a user to rebalance the database shards.

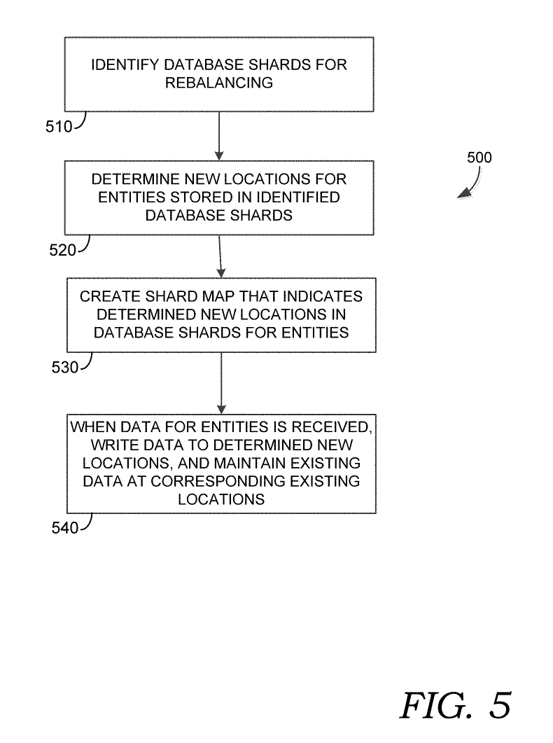

With reference to FIG. 5, another flow diagram that illustrates an exemplary method 500 for rebalancing database shards is provided.

At block 510, database shards are identified for rebalancing. In some embodiments, performance of the database shards is analyzed using a performance metric. For those shards that have poor performance, entities can be identified to be relocated to other database shards. In some embodiments, entities in the database shards that have a high utilization rate may be candidates for relocation based on the performance of the rest of the shards.

At block 520, locations in the database shards are determined for entities stored in the identified database shards. In some embodiments, performance of the database shards is analyzed using a performance metric. For those shards that are underutilized, those shards can be used as new locations for the entities of the identified database shards in block 510. For example, if a new database shard is added, it will likely be underutilized, leading to the new database shard to likely be used as a new location for the entities of the identified database shards in block 510.

At block 530, a shard map that indicates the determined new locations in the database shards for the entities of the identified database shards is created. In some embodiments, the shard map has a different version identifier from previous shard maps. The new shard map is a default shard map. In some embodiments, the new shard map increments the version number of the previous shard map to get a new version number. The entities and locations in the new shard map also correspond to the new version number, i.e., a version number incremented from the previous version number.

At block 540, when data for the entities is received, the data for the entities is stored to the determined new locations in the database shards indicated by the shard map. In some embodiments, data for the entities is received from an external data source, such as a customer data file. In other words, new entities are created for the entities of the identified database shards in the new locations. In some embodiments, the new entities are given a version identifier that corresponds to the shard map created in block 530. The existing data for the entities in the data shards, i.e., the previous versions of the data, is not moved from their corresponding existing locations in the database shards.

In some embodiments, prior to identifying the database shards, an indication to rebalance the database shards may be received. For example, the database shard system may determine that at least one of the database shards is exhibiting reduced performance and thus the database shards should be rebalanced. As another example, the rebalancing may be performed on a preset schedule, e.g., weekly, monthly, etc. The determination to rebalance database shard is not limited to the above examples, and any means of determining to rebalance database shards may be employed. For example, a request is received by a user to rebalance the database shards.

In some embodiments, the new shard map replaces a previous shard map. Since versioning is performed on the shard maps, the old version of the shard map may still be retained. However, operations on the database may be set to use the latest version of the shard map. By retaining the older shard maps, previous versions of data can still be accessed (prior to the data being garbage collected). The old data and location may be determined by a previous shard map and the new data and location may be determined by the new shard map. Thus, previous versions of the entity may be accessed by their version number.

Since the data in a database shard is not moved, issues where the data may be corrupted during a move process are prevented. For example, if the system fails during a move process, entities data may be lost or corrupted. By not moving data, the risk of losing data during a system failure is decreased. Furthermore, no downtime is required to rebalance the shards, which allows for the more efficient operation of the database. The described database shard rebalancing system can support any possible database schema even when it is very complex and key values in each shard have been decided autonomously. Furthermore, the rebalancing can be performed in rule-based automatic and manual way. Thus, the described database shard rebalancing system improves system performance automatically without supervision and provides optimized performance when the latest information for an entity is queried.

Having briefly described an overview of embodiments of the present invention, an exemplary operating environment in which embodiments of the present invention may be implemented is described below in order to provide a general context for various aspects of the present invention. In particular, an exemplary operating environment for implementing embodiments of the present invention is designated generally as a computing device. A computing device is only one example of a suitable computing environment and is not intended to suggest any limitation as to the scope of use or functionality of the invention. Neither should the computing device be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

The computing device includes a bus that directly or indirectly couples the following devices: memory and one or more processors. Also, processors have memory. The bus represents what may be one or more busses (such as an address bus, data bus, or combination thereof).

A computing device typically includes a variety of computer-readable media. Computer-readable media can be any available media that can be accessed by the computing device and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory includes computer storage media in the form of volatile and/or nonvolatile memory. The memory may be removable, non-removable, or a combination thereof. Exemplary hardware devices include solid-state memory, hard drives, optical-disc drives, etc. The computing device includes one or more processors that read data from various entities such as the memory.

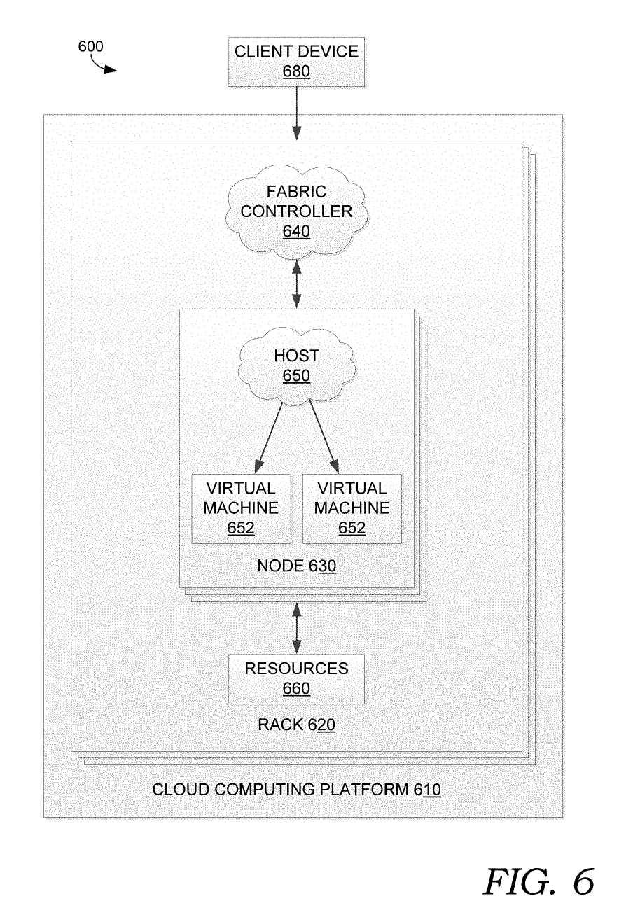

Referring now to FIG. 6, FIG. 6 illustrates an exemplary distributed computing environment 600 in which implementations of the present disclosure may be employed. In particular, FIG. 6 shows a high level architecture of the infrastructure management system (“system”) in a cloud computing platform 610, where the system supports seamless modification of software component. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

Data centers can support the distributed computing environment 600 (e.g., centralized infrastructure and edge infrastructure) that includes the cloud computing platform 610, rack 620, and node 630 (e.g., computing devices, processing units, or blades) in rack 620. The system can be implemented with a cloud computing platform 610 that runs cloud services across different data centers and geographic regions. The cloud computing platform 610 can implement a fabric controller 640 component for provisioning and managing resource allocation, deployment, upgrade, and management of cloud services. Typically, the cloud computing platform 610 acts to store data or run service applications in a distributed manner. The cloud computing infrastructure 610 in a data center can be configured to host and support operation of endpoints of a particular service application. The cloud computing infrastructure 610 may be a public cloud, a private cloud, or a dedicated cloud.

The node 630 can be provisioned with a host 650 (e.g., operating system or runtime environment) running a defined software stack on the node 630. Node 630 can also be configured to perform specialized functionality (e.g., compute nodes or storage nodes) within the cloud computing platform 610. The node 630 is allocated to run one or more portions of a service application of a tenant. A tenant can refer to a customer utilizing resources of the cloud computing platform 610. Service application components of the cloud computing platform 610 that support a particular tenant can be referred to as a tenant infrastructure or tenancy. The terms service application, application, or service are used interchangeably herein and broadly refer to any software, or portions of software, that run on top of, or access storage and compute device locations within, a datacenter.

When more than one separate service application is being supported by the nodes 630, the nodes may be partitioned into virtual machines (e.g., virtual machine 652 and virtual machine 654). Physical machines can also concurrently run separate service applications. The virtual machines or physical machines can be configured as individualized computing environments that are supported by resources 660 (e.g., hardware resources and software resources) in the cloud computing platform 610. It is contemplated that resources can be configured for specific service applications. Further, each service application may be divided into functional portions such that each functional portion is able to run on a separate virtual machine. In the cloud computing platform 610, multiple servers may be used to run service applications and perform data storage operations in a cluster. In particular, the servers may perform data operations independently but exposed as a single device referred to as a cluster. Each server in the cluster can be implemented as a node.

Client device 680 may be linked to a service application in the cloud computing platform 610. The client device 680 may be any type of computing device, which may correspond to a generic computing device. The client device 680 can be configured to issue commands to cloud computing platform 610. In embodiments, client device 680 may communicate with service applications through a virtual Internet Protocol (IP) and load balancer or other means that directs communication requests to designated endpoints in the cloud computing platform 610. The components of cloud computing platform 610 may communicate with each other over a network (not shown), which may include, without limitation, one or more local area networks (LANs) and/or wide area networks (WANs).

Having described various aspects of the distributed computing environment 600 and cloud computing platform 610, it is noted that any number of components may be employed to achieve the desired functionality within the scope of the present disclosure. Although the various components of FIG. 6 are shown with lines for the sake of clarity, in reality, delineating various components is not so clear, and metaphorically, the lines may more accurately be grey or fuzzy. Further, although some components of FIG. 6 are depicted as single components, the depictions are exemplary in nature and in number and are not to be construed as limiting for all implementations of the present disclosure.

Embodiments described in the paragraphs above may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present invention are described with reference to a distributed computing environment; however the distributed computing environment depicted herein is merely exemplary. Components can be configured for performing novel aspects of embodiments, where configured for comprises programmed to perform particular tasks or implement particular abstract data types using code. Further, while embodiments of the present invention may generally refer to the distributed computing environment and the schematics described herein, it is understood that the techniques described may be extended to other implementation contexts.

Embodiments of the present invention have been described in relation to particular embodiments which are intended in all respects to be illustrative rather than restrictive. Alternative embodiments will become apparent to those of ordinary skill in the art to which the present invention pertains without departing from its scope.

From the foregoing, it will be seen that this invention in one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

The invention claimed is:

1. A computer-implemented method for rebalancing database shards, the method comprising:
identifying candidate entities in the database shards for rebalancing, the identified candidate entities having corresponding existing locations in the database shards;
determining new locations in the database shards for the identified candidate entities;
creating a shard map that identifies the new locations in the database shards for the identified candidate entities; and
when data for the identified candidate entities is received, writing the data for the identified candidate entities to the new locations identified in the shard map, and maintaining existing data for the identified candidate entities at the corresponding existing locations in the database shards.

2. The method of claim 1, wherein the method further comprises receiving an indication to rebalance the database shards prior to identifying the candidate entities.

3. The method of claim 1, wherein the method further comprises:
receiving the data for the identified candidate entities prior to the identifying candidate entities; and
wherein the identifying candidate entities comprise identifying candidate entities based on the received data.

4. The method of claim 1, wherein the maintaining existing data comprises not moving the existing data for the identified candidate entities from the corresponding existing locations in the database shards.

5. The method of claim 1, wherein the method further comprises:
creating a database shard comprising one or more of the new locations; and
wherein the writing the data comprises writing the data for at least one candidate entity to the created database shard having a corresponding new location of the at least one candidate.

6. The method of claim 1, wherein the data for the identified candidate entities is received from an external data source.

7. The method of claim 1, wherein the method further comprises:
receiving data for an entity not identified for rebalancing; and
writing the received data for the entity not identified for rebalancing to the corresponding existing location for the entity.

8. The method of claim 1, wherein the method further comprises:
incrementing a version number for entities in the created shard map; and
wherein each of the new locations in the shard map is different from a corresponding location in a prior shard map.

9. The method of claim 8, wherein the method further comprises:
accessing an entity by version number, the version number corresponding to one of the locations in the created shard map or the prior shard map.

10. A computer-readable storage media storing instructions that, when executed by one or more processors, rebalance database shards, the instructions causing the one or more processors to:
identify database shards for rebalancing, a database shard comprising one or more entities, each entity having a corresponding existing location in the database shards;
determine new locations in the database shards for one or more of the entities stored in the identified database shards;
create a shard map that indicates the determined new locations in the database shards for the one or more of the entities; and
when data for the one or more of the entities is received, write the data to the determined new locations in the database shards indicated by the shard map, and maintain existing data for the one or more of the entities at the corresponding existing locations in the database shards.

11. The computer-readable storage media of claim 9, wherein the maintaining existing data comprises not moving the existing data from the corresponding existing locations in the database shards.

12. The computer-readable storage media of claim 9, wherein the identified database shards for rebalancing are identified based on a performance metric of the database shards.

13. The computer-readable storage media of claim 9, wherein the determined new locations are determined based on a performance metric of the database shards.

14. The computer-readable storage media of claim 9, wherein the instructions further cause the one or more processors to receive, prior to identifying the candidate entities, an indication to rebalance the database shards.

15. The computer-readable storage media of claim 9, wherein the instructions further cause the one or more processors to assign a version number to the one or more of the entities in the created shard map corresponding to the created shard map.

16. The computer-readable storage media of claim 9, wherein the instructions further cause the one or more processors to retrieve an entity by a corresponding version number, the version number corresponding to one of the locations in the created shard map or a prior shard map.

17. A system comprising:
a query manager configured to:
communicate with a shard map manager for locations in database shards of queried entities; and
retrieve entity data from the database shards corresponding to the queried entities;
a plurality of database shards configured to:
store the entity data, a database shard comprising one or more entities, each entity having a corresponding existing location in the database shard;
the shard map manager configured to:
create a shard map that identifies the database shard locations in the database shards for the entity data, a new database shard location being identified for each candidate entity identified for rebalancing; and
a rebalancing manager configured to:
identify the candidate entities in the database shards for rebalancing;
determine the new database shard locations in the database shards for the identified candidate entities; and
when data for the entities is received from an external data source, write the received data to the database shard locations identified in the shard map corresponding to the entities, and maintain existing data for the entities at the corresponding existing locations in the database shards.

18. The system of claim 17, wherein the maintaining existing data comprises not moving the existing data for the entities from the corresponding existing locations in the database shards.

19. The system of claim 17, wherein at least one of the determined locations is a database shard not containing any entities.

20. The system of claim 17, wherein the created shard map is a latest shard map.
